(19) United States
(12) Patent Application Publication
(10) Pub. No.: US 2025/0145176 A1
(43) Pub. Date: May 8, 2025

(54) LLM-BASED HYBRID PLANNER FOR AUTONOMOUS DRIVING

(71) Applicant: NEC Laboratories America, Inc., Princeton, NJ (US)

(72) Inventors: Manmohan Chandraker, Santa Clara, CA (US); Francesco Pittaluga, Los Angeles, CA (US); Vijay Kumar Baikampady Gopalkrishna, Santa Clara, CA (US); Sharan Satish Prema, Austin, TX (US)

(21) Appl. No.: 18/934,817

(22) Filed: Nov. 1, 2024

Related U.S. Application Data
(60) Provisional application No. 63/595,487, filed on Nov. 2, 2023.
(60) Provisional application No. 63/599,536, filed on Nov. 15, 2023.

(51) Int. Cl. B60W 60/00; B60W 10/04; B60W 10/18; B60W 10/20; G05D 1/43; G06F 8/35; G06F 11/34

(52) U.S. Cl. CPC B60W 60/001; B60W 10/04; B60W 10/18; B60W 10/20; G05D 1/43; G06F 8/35; G06F 11/3457

(57) ABSTRACT

Methods and systems for operating a vehicle include prompting a large language model LLM to generate parameters for a rule-based planner based on historical data for vehicles in a road scene. A trajectory is generated using the parameters. A driving action is performed to implement the trajectory.

### RELATED APPLICATION INFORMATION

This application claims priority to U.S. Patent Application No. 63/595,487, filed on Nov. 2, 2023, and to U.S. Patent Application No. 63/599,536, filed on Nov. 15, 2023, each incorporated herein by reference in its entirety.

### BACKGROUND

### Technical Field

The present invention relates to autonomous driving and, more particularly, to combining text-based scene descriptions and visual information.

### Description of the Related Art

Visual information is used to plan the path for an autonomous vehicle, making it possible for the vehicle to identify road features and hazards and create a safe plan for reaching a target location. However, the planning can be challenging as it can involve a number of different intermediate objectives that must be addressed in a short period of time. Additionally, operating based solely on visual information can provide an incomplete understanding of a road scene, as the planning system may fail to account for the semantic meaning of parts of the scene.

### SUMMARY

A method for operating a vehicle includes prompting a large language model LLM to generate parameters for a rule-based planner based on historical data for vehicles in a road scene. A trajectory is generated using the parameters. A driving action is performed to implement the trajectory.

A system for operating a vehicle includes a hardware processor and a memory that stores a computer program. When executed by the hardware processor, the computer program causes the hardware processor to prompt an LLM to generate parameters for a rule-based planner based on historical data for vehicles in a road scene, to generate a trajectory using the parameters, and to perform a driving action to implement the trajectory.

A vehicle includes a hardware processor, an equipment control unit (ecu) that controls at least one driving system of the vehicle, and a memory that stores a computer program. When executed by the hardware processor, the computer program causes the hardware processor to prompt an LLM to generate parameters for a rule-based planner based on historical data for vehicles in a road scene, to generate a trajectory using the parameters, and to trigger the ECU to perform a driving action to implement the trajectory, selected from the group consisting of a braking action, a steering action, and an acceleration action.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a top-down view of a road scene with a self-driving vehicle, in accordance with an embodiment of the present invention;

FIG. 2 is a diagram illustrating equipment within a self-driving vehicle, including a controller that has a hybrid planner, in accordance with an embodiment of the present invention;

FIG. 3 is a block diagram of a controller with a hybrid controller and task decomposition, in accordance with an embodiment of the present invention;

FIG. 4 is a block diagram of task decomposition, in accordance with an embodiment of the present invention;

FIG. 5 is a block diagram of a hybrid planner, in accordance with an embodiment of the present invention;

FIG. 6 is a block diagram of a computing device that can perform hybrid planning and task decomposition, in accordance with an embodiment of the present invention;

FIG. 7 is a diagram of an exemplary neural network architecture that can be used to implement part of a large language model (LLM), in accordance with an embodiment of the present invention;

FIG. 8 is a diagram of an exemplary deep neural network architecture that can be used to implement part of an LLM, in accordance with an embodiment of the present invention; and

FIG. 9 is a block/flow diagram of a method for controlling a vehicle, in accordance with an embodiment of the present invention.

### DETAILED DESCRIPTION OF PREFERRED EMBODIMENTS

To decrease the complexity of planning a path through a road scene, the problem can be decomposed into easier-to-achieve sub-goals. In cases where sub-goals do not exist within the scope of actions that a planner can execute, new planner code can be generated to achieve a behavior sub-goal. Additionally, a large language model (LLM) may be used to extract information from text-based scene descriptions to provide parameters for the planner. An unconstrained hybrid rule- and LLM-based planner can thus be used to generate a navigational plan for the vehicle in two-dimensional (2D) coordinates).

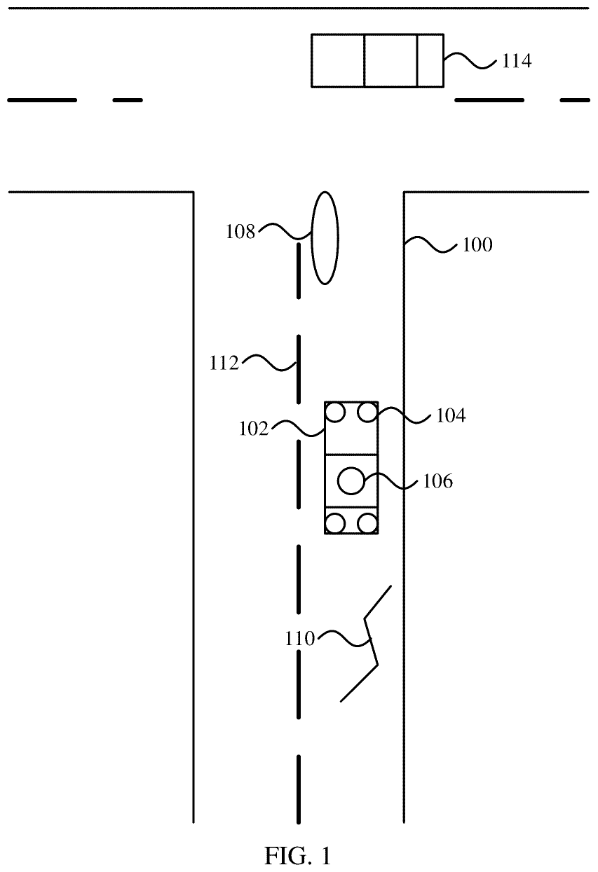

Referring now to FIG. 1, an exemplary road scene is shown. A vehicle 102 operates on a road 100. The vehicle 102 is equipped with sensors that collect information about the road 100. For example, the vehicle 102 may include several video cameras 104, positioned at different locations around the vehicle, to obtain visual information about the road 100 from multiple different perspectives and to provide a wide area of the scene. The vehicle 102 may further include a 360-degree LiDAR sensor 106, positioned to gather geometric information about the road 100 all around the vehicle 102.

The vehicle 102 records information from its sensors. The information may be used to identify flaws in the road 100 and other road features, which can be used to inform safe operation of the vehicle. The sensors may also collect information relating to other objects in the environment, such as other vehicles 114, structural features such as lamp posts, as well as animals and pedestrians.

Exemplary infrastructure defects and faults include potholes 108, ruts, cracks 110, and fading in road markings 112. Other types of defect and faults may include obstructions or foliage that falls or reaches onto the roadway. These flaws may appear on one or both modalities. For example, LiDAR information is sensitive to geometric information and will indicate the shape of the road's surface. This is particularly useful for detecting potholes 108 and cracks 110, but LiDAR sensors 106 may have difficulty identifying defects in the road markings 112. The visual sensors 104, meanwhile, would be well adapted to defects in road markings 112, but may miss potholes 108 and cracks 110 in adverse lighting conditions. Additionally, when used in combination, the different modalities reinforce one another and provide superior results even in cases where each would independently be able to recognize the road flaw.

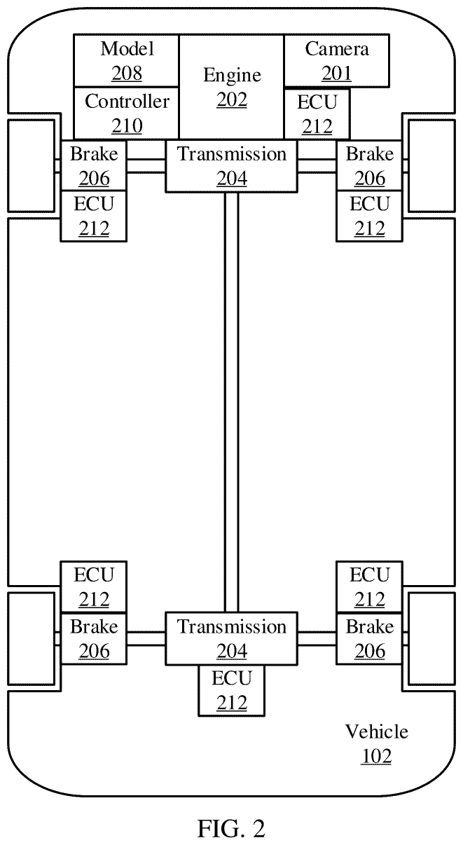

Referring now to FIG. 2, additional detail on a vehicle 102 is shown. A number of different sub-systems of the vehicle 102 are shown, including an engine 202, a transmission 204, and brakes 206. It should be understood that these sub-systems are provided for the sake of illustration, and should not be interpreted as limiting. Additional sub-systems may include user-facing systems, such as climate control, user interface, steering control, and braking control. Additional sub-systems may include systems that the user does not directly interact with, such as tire pressure monitoring, location sensing, collision detection and avoidance, and self-driving.

Each sub-system is controlled by one or more equipment control units (ECUs) 212, which perform measurements of the state of the respective sub-system. For example, ECUs 212 relating to the brakes 206 may control an amount of pressure that is applied by the brakes 206. An ECU 212 associated with the wheels may further control the direction of the wheels. The information that is gathered by the ECUs 212 is supplied to the controller 210. A camera 201 or other sensor (e.g., LiDAR or RADAR) can be used to collect information about the surrounding road scene, and such information may also be supplied to the controller 210.

Communications between ECUs 212 and the sub-systems of the vehicle 102 may be conveyed by any appropriate wired or wireless communications medium and protocol. For example, a car area network (CAN) may be used for communication. The time series information may be communicated from the ECUs 212 to the controller 210, and instructions from the controller 210 may be communicated to the respective sub-systems of the vehicle 102.

The controller 210 uses the output of the object detection model 208, based on information collected from cameras 201, to identify objects and hazards within the scene. The model 208 may, for example, determine a driving action to perform responsive to the present state of the scene. Because the model 208 has been trained on diverse simulated inputs, it will determine a safe and efficient path to its destination.

The controller 210 may communicate internally to the sub-systems of the vehicle 102 and the ECUs 212. Based on detected road fault information, the controller 210 may communicate instructions to the ECUs 212 to avoid a hazardous road condition. For example, the controller 210 may automatically trigger the brakes 206 to slow down the vehicle 102 and may furthermore provide steering information to the wheels to cause the vehicle 102 to move around a hazard.

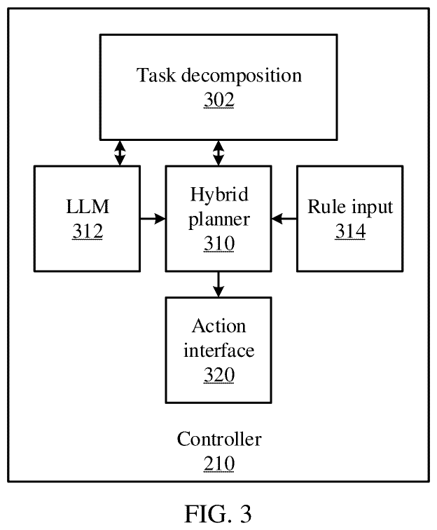

Referring now to FIG. 3, additional detail on the controller 210 is shown. A hybrid planner 310 makes decisions as to how to control the vehicle 102 in communication with task decomposition 302, which breaks the plan up into achievable sub-plans. The hybrid planner 310 makes its decisions based on input from an LLM 312 and a rule input 314, invoking the LLM 312 based on scores of the hybrid planner 310 to balance the strengths of both the LLM 312 and the rule input 314. The hybrid planner 310 thus processes text-based scene descriptions as input using the LLM 312 to generate a navigational plan for the vehicle 102.

The action interface 320 communicates with the ECUs 212 of the vehicle 102 to provide instructions as to how they operate their respective components. For example, the action interface 320 may trigger the brakes 206 to decelerate the vehicle 102, may trigger the engine 202 to accelerate the vehicle, and may cause the wheels to turn in a steering action.

Task decomposition 302 further makes use of the LLM 312 to determine behavior sub-goals or novel actions that provide planning in complex scenes with higher-level reasoning. Task decomposition 302 develops a semantic representation of the road scene, encoding important properties like scene element, traffic agent positions and their velocities, and converts this representation to a natural language format. The LLM 312 may be prompted to produce the sub-goals that the vehicle 102 should execute to safely navigate. If the actions are outside the scope of the hybrid planner 310, then the LLM 312 may further be prompted to generate new planner code that the controller 210 can use to achieve the sub-goals.

The task decomposition 302 and hybrid planner 310 use a training and inference framework for driving in complex road scenes, where the LLM 312 can be queried to generate plans when the hybrid planner 310 cannot navigate to a goal safely and comfortably unaided. The prompting for the LLM 312 may be based on system information, chain of thought, and few-shot examples.

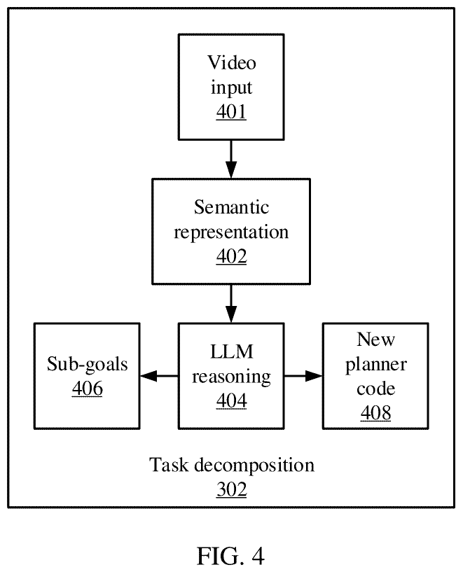

Referring now to FIG. 4, additional detail on task decomposition 302 is shown. A video input 401 is provided from camera(s) 201, and may include two-dimensional information or three-dimensional information from a road scene. Hybrid planner 310 uses rule-based and learning-based planners, but can further use LLM-based reasoning for handling challenging and uncertain scenarios. Task decomposition 302 may be used when the hybrid planner 310 generates an output that has below-threshold scores for metrics such as collision risk, obeying traffic rules, and/or passenger comfort.

Block 402 generates a scene representation that is converted into a natural language format. LLM reasoning 404 prompts the LLM 312 with the natural language representation of the road scene, so that the LLM 312 can process the current scenario's observations, including vehicular positioning, traffic light status and lane information, and trajectories generated by the hybrid planner 310 and their corresponding scores.

The LLM reasoning 404 uses distinct primitives to implement high-level behaviors like lane switching, side shifts, obstacle avoidance, and vehicle pull-out or pull-over maneuvers. The LLM reasoning 404 can navigate the scene through behavior sub-goals 406. The hybrid planner 310 generates trajectory proposals at each planning stage, along with corresponding scores, each characterized by varying velocities and center-lane offsets. These proposals may be updated regularly using an internal simulator, which applies metrics for safety, rule-following, and comfort.

The LLM reasoning 404 adjusts parameters of the hybrid planner 310 to execute actions needed to achieve sub-goals within target safety and comfort metrics. If none of the generated trajectories are executable by the hybrid planner 310, the LLM reasoning 404 generates intermediate behavior sub-goals 406 based on its knowledge-driven understanding of the complex scene. If the sub-goals are achievable by the hybrid planner 310, then the plan is executed.

If the sub-goals 406 are not executable by the hybrid planner 310, then the LLM reasoning 404 invokes code understanding to write new planner code 408, which is consistent with the logic of the hybrid planner 310, the set of actions allowed by the action interface 320, traffic rules, and the current scenario. The new planner code 408 is executed to navigate the complex scene in a manner that satisfies the target metrics.

For example, the LLM reasoning 404 may prompt the LLM 312 with a goal that states the vehicle's current position within a road scene, describes the positions and velocities of other vehicles, and instructs the LLM 312 to generate achievable sub-goals 406 to reach a target destination. The prompt may include context that sets parameters, such as rules and formatting for how the output is to be generated.

When generating new planner code 408, a prompt may be supplied to the LLM 312 to generate code to achieve a goal that the hybrid planner 310 is not already capable of. The planner outputs a score for a given trajectory, and this score may be compared to a threshold to determine whether a given sub-goal is executable. The prompt may include instructions that describe the planner's inputs and outputs and may provide example code to inform the LLM 312 how the generated code should be structured.

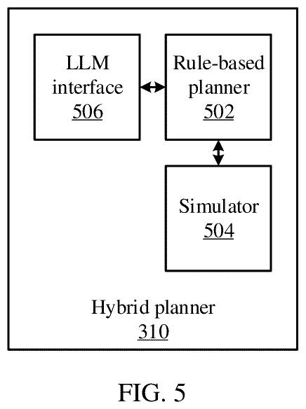

Referring now to FIG. 5, additional detail on the hybrid planner 310 is shown. A rule-based planner 502 is used as the basis for the hybrid planner 310, with the LLM 312 being used for challenging scenarios that the rule-based planner 502 cannot solve. A constant-velocity real-time simulator 504 is used to identify scenarios that the rule-based planner 502 cannot solve, so that proposals from the rule-based planner 502 can he scored and so that the LLM interface 506 is invoked when the scores fall below a predetermined threshold.

For both the rule-based planner 502 and the real-time simulator 504, a set (e.g., fifteen) of trajectory proposals for the vehicle 102 may be generated at each time-step. For each proposal, a simulation is performed that considers all agents within a certain radius (e.g., 50 meters) and the top-scoring proposal, according to a predetermined metric, is selected. If the top-scoring proposal is shown to collide with another agent within a predetermined time period (e.g., 2 seconds), an emergency brake function may be triggered. Exemplary metrics include a score for at-fault collisions, compliance with the legal driving area, progress toward a destination, compliance with legal driving directions, time to collision, speed limit compliance, progress along an expert route, and passenger comfort.

The trajectories are generated by considering all possible combinations of two hyperparameters: centerline offset distance and target speed measured as a percentage of the local speed limit. Given a centerline offset o and a current velocity v, the longitudinal acceleration for a proposal may be generated as:

$$\frac{dv}{dt} = a ( 1 - {( \frac{v}{{v}_{0}} )}^{δ} - {( \frac{{s}^{*}}{s} )}^{2} )$$

where a denotes an acceleration limit, s* is a safety margin, and δ is a jerk exponent.

The LLM interface 506 considers the most unconstrained version of the planning problem, in which the LLM 312 directly returns a safe future trajectory for the vehicle 102. For this task, a prompt includes a task overview, a description of the state of the scene, and task requirements that include generating a trajectory and a rationale. This rationale can give transparency as to why the LLM selects a given course of action.

The LLM interface 506 uses a parameterized version of the planning problem. Rather than directly returning a future trajectory for the vehicle 102, the LLM 312 returns a set of parameters to be used by the rule-based planner 502 to plan a safe trajectory. The LLM interface 506 issues a prompt at each time step, providing updated scene information that includes the history of positions, headings, and speeds for vehicles, pedestrians, and objects, along with a current lane identifier for each. The LLM interface 506 thereby obtains parameters that may include a lateral offset of the vehicle 102 relative to a lane center, a fraction of the speed limit in free traffic, a fallback speed in free traffic, a minimum distance to a lead car, a minimum time to the lead car, a maximum acceleration, and a maximum deceleration.

The LLM 312 further provides a one-sentence explanation for why a specific trajectory was chosen. The LLM interface 506 queries the LLM 312 multiple times for a given time step, until a trajectory is proposed that has a predicted score meeting a predefined threshold, or a number of queries per time step exceeds a maximum number. If the maximum number of queries is exceeded, the trajectory with the highest predicted score is selected. The simulation may be repeated for the trajectories that are generated using the LLM's parameters.

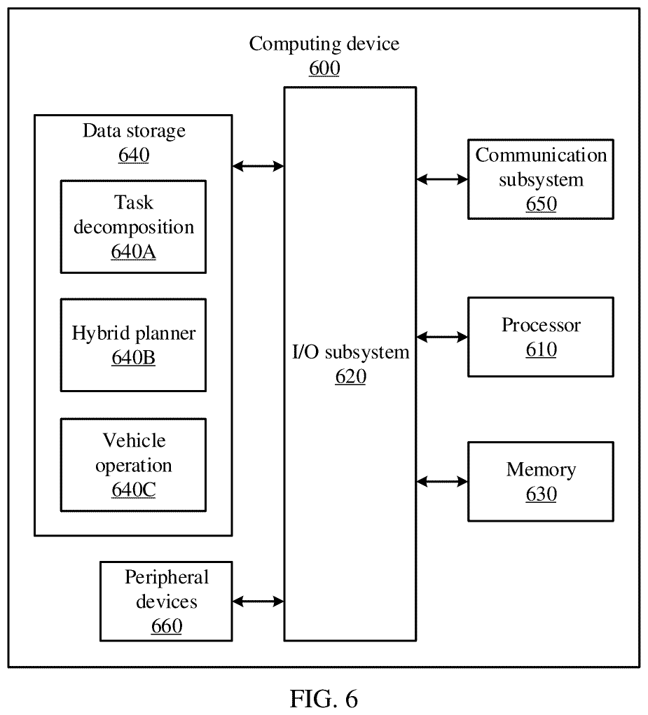

Referring now to FIG. 6, an exemplary computing device 600 is shown, in accordance with an embodiment of the present invention. The computing device 600 may be embodied as any type of computation or computer device capable of performing the functions described herein, including, without limitation, a computer, a server, a rack based server, a blade server, a workstation, a desktop computer, a laptop computer, a notebook computer, a tablet computer, a mobile computing device, a wearable computing device, a network appliance, a web appliance, a distributed computing system, a processor-based system, and/or a consumer electronic device. Additionally or alternatively, the computing device 600 may be embodied as one or more compute sleds, memory sleds, or other racks, sleds, computing chassis, or other components of a physically disaggregated computing device.

As shown in FIG. 6, the computing device 600 illustratively includes the processor 610, an input/output subsystem 620, a memory 630, a data storage device 640, and a communication subsystem 650, and/or other components and devices commonly found in a server or similar computing device. The computing device 600 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 630, or portions thereof, may be incorporated in the processor 610 in some embodiments.

The processor 610 may be embodied as any type of processor capable of performing the functions described herein. The processor 610 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 630 may be embodied as any type of volatile or non-volatile memory or data storage capable of performing the functions described herein. In operation, the memory 630 may store various data and software used during operation of the computing device 600, such as operating systems, applications, programs, libraries, and drivers. The memory 630 is communicatively coupled to the processor 610 via the I/O subsystem 620, which may be embodied as circuitry and/or components to facilitate input/output operations with the processor 610, the memory 630, and other components of the computing device 600. For example, the I/O subsystem 620 may be embodied as, or otherwise include, memory controller hubs, input/output control hubs, platform controller hubs, integrated control circuitry, firmware devices, communication links (e.g., point-to-point links, bus links, wires, cables, light guides, printed circuit board traces, etc.), and/or other components and subsystems to facilitate the input/output operations. In some embodiments, the I/O subsystem 620 may form a portion of a system-on-a-chip (SOC) and be incorporated, along with the processor 610, the memory 630, and other components of the computing device 600, on a single integrated circuit chip.

The data storage device 640 may be embodied as any type of device or devices configured for short-term or long-term storage of data such as, for example, memory devices and circuits, memory cards, hard disk drives, solid state drives, or other data storage devices. The data storage device 640 can store program code 640A for task decomposition, 640B for a hybrid planner, and/or 640C for performing vehicle operation actions using the trained planner model. Any or all of these program code blocks may be included in a given computing system. The communication subsystem 650 of the computing device 600 may be embodied as any network interface controller or other communication circuit, device, or collection thereof, capable of enabling communications between the computing device 600 and other remote devices over a network. The communication subsystem 650 may be configured to use any one or more communication technology (e.g., wired or wireless communications) and associated protocols (e.g., Ethernet, InfiniBand®, Bluetooth®, Wi-Fi®, WiMAX, etc.) to effect such communication.

As shown, the computing device 600 may also include one or more peripheral devices 660. The peripheral devices 660 may include any number of additional input/output devices, interface devices, and/or other peripheral devices. For example, in some embodiments, the peripheral devices 660 may include a display, touch screen, graphics circuitry, keyboard, mouse, speaker system, microphone, network interface, and/or other input/output devices, interface devices, and/or peripheral devices.

Of course, the computing device 600 may also include other elements (not shown), as readily contemplated by one of skill in the art, as well as omit certain elements. For example, various other sensors, input devices, and/or output devices can be included in computing device 600, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized. These and other variations of the processing system 600 are readily contemplated by one of ordinary skill in the art given the teachings of the present invention provided herein.

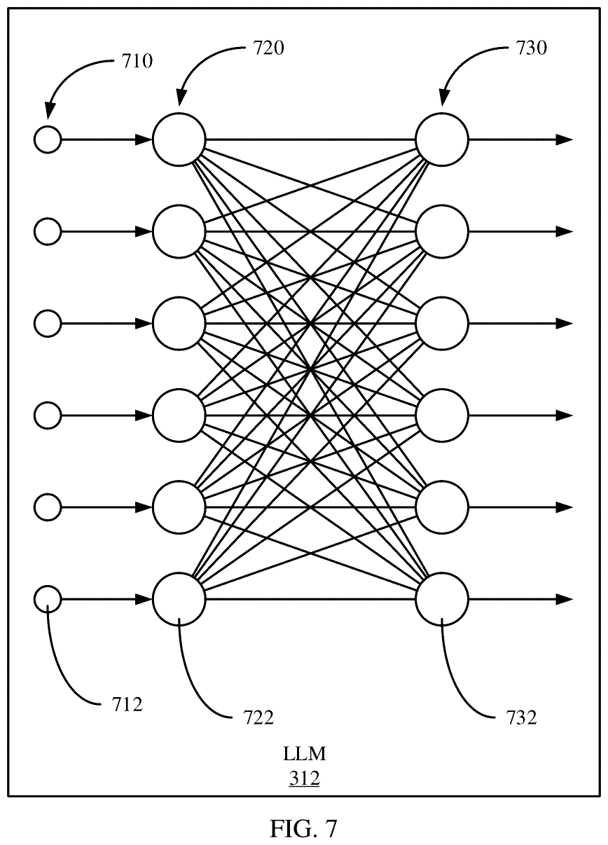

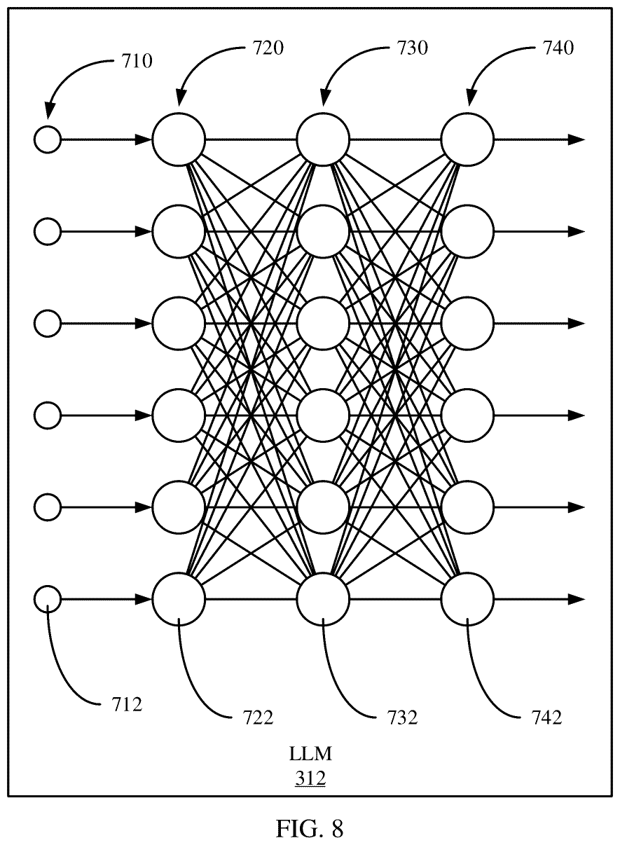

Referring now to FIGS. 7 and 8, exemplary neural network architectures are shown, which may be used to implement parts of the present models, such as the LLM 312. A neural network is a generalized system that improves its functioning and accuracy through exposure to additional empirical data. The neural network becomes trained by exposure to the empirical data. During training, the neural network stores and adjusts a plurality of weights that are applied to the incoming empirical data. By applying the adjusted weights to the data, the data can be identified as belonging to a particular predefined class from a set of classes or a probability that the input data belongs to each of the classes can be output.

The empirical data, also known as training data, from a set of examples can be formatted as a string of values and fed into the input of the neural network. Each example may be associated with a known result or output. Each example can be represented as a pair, (x, y), where x represents the input data and y represents the known output. The input data may include a variety of different data types, and may include multiple distinct values. The network can have one input node for each value making up the example's input data, and a separate weight can be applied to each input value. The input data can, for example, be formatted as a vector, an array, or a string depending on the architecture of the neural network being constructed and trained.

The neural network “learns” by comparing the neural network output generated from the input data to the known values of the examples, and adjusting the stored weights to minimize the differences between the output values and the known values. The adjustments may be made to the stored weights through back propagation, where the effect of the weights on the output values may be determined by calculating the mathematical gradient and adjusting the weights in a manner that shifts the output towards a minimum difference. This optimization, referred to as a gradient descent approach, is a non-limiting example of how training may be performed. A subset of examples with known values that were not used for training can be used to test and validate the accuracy of the neural network.

During operation, the trained neural network can be used on new data that was not previously used in training or validation through generalization. The adjusted weights of the neural network can be applied to the new data, where the weights estimate a function developed from the training examples. The parameters of the estimated function which are captured by the weights are based on statistical inference.

In layered neural networks, nodes are arranged in the form of layers. An exemplary simple neural network has an input layer 720 of source nodes 722, and a single computation layer 730 having one or more computation nodes 732 that also act as output nodes, where there is a single computation node 732 for each possible category into which the input example could be classified. An input layer 720 can have a number of source nodes 722 equal to the number of data values 712 in the input data 710. The data values 712 in the input data 710 can be represented as a column vector. Each computation node 732 in the computation layer 730 generates a linear combination of weighted values from the input data 710 fed into input nodes 720, and applies a non-linear activation function that is differentiable to the sum. The exemplary simple neural network can perform classification on linearly separable examples (e.g., patterns).

A deep neural network, such as a multilayer perceptron, can have an input layer 720 of source nodes 722, one or more computation layer(s) 730 having one or more computation nodes 732, and an output layer 740, where there is a single output node 742 for each possible category into which the input example could be classified. An input layer 720 can have a number of source nodes 722 equal to the number of data values 712 in the input data 710. The computation nodes 732 in the computation layer(s) 730 can also be referred to as hidden layers, because they are between the source nodes 722 and output node(s) 742 and are not directly observed. Each node 732, 742 in a computation layer generates a linear combination of weighted values from the values output from the nodes in a previous layer, and applies a non-linear activation function that is differentiable over the range of the linear combination. The weights applied to the value from each previous node can be denoted, for example, by w₁, w₂, . . . wₙ₋₁, wₙ. The output layer provides the overall response of the network to the input data. A deep neural network can be fully connected, where each node in a computational layer is connected to all other nodes in the previous layer, or may have other configurations of connections between layers. If links between nodes are missing, the network is referred to as partially connected.

Training a deep neural network can involve two phases, a forward phase where the weights of each node are fixed and the input propagates through the network, and a backwards phase where an error value is propagated backwards through the network and weight values are updated.

The computation nodes 732 in the one or more computation (hidden) layer(s) 730 perform a nonlinear transformation on the input data 712 that generates a feature space. The classes or categories may be more easily separated in the feature space than in the original data space.

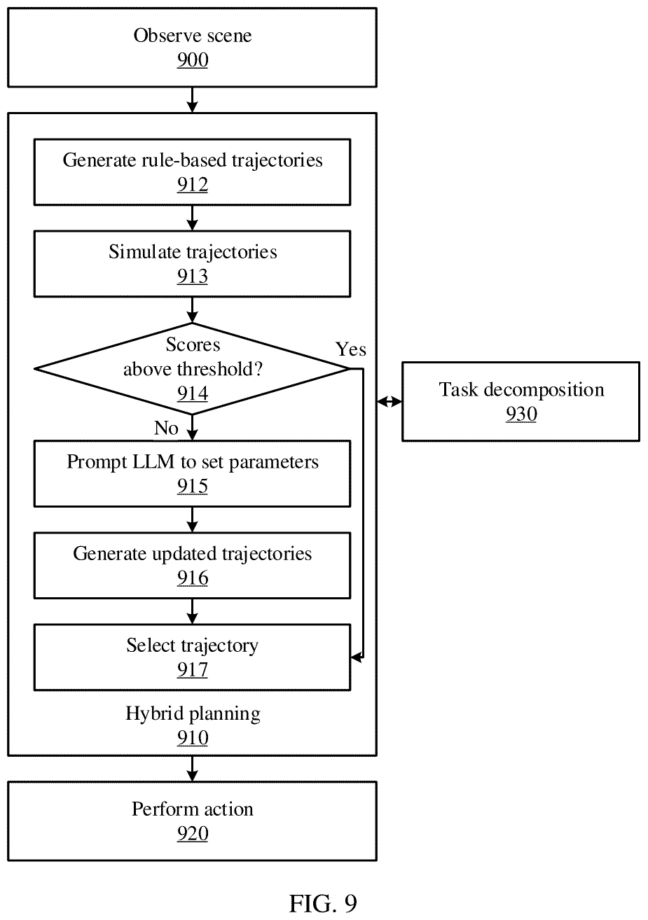

Referring now to FIG. 9, a method for controlling an autonomously driven vehicle is shown. Block 900 observes a road scene around the vehicle 102, for example using cameras and any other appropriate sensors to collect information about vehicles, people, and objects in the scene. Block 910 performs hybrid planning, which may make use of a rule-based planner 502 and may further use an LLM 312 to set parameters of the rule-based planner 502.

Block 912 generates a first set of trajectories using the rule-based planner 502, based on collected information about the road scene. Block 913 then simulates the first set of trajectories using simulator 504, generating one or more scores for each of the first set of trajectories according to appropriate metrics. Block 914 determines whether the scores are above predetermined thresholds and, if so, a top-scoring trajectory is selected 917.

If one or more scores are below a respective threshold for all of the first set of trajectories, block 915 prompts the LLM 312 to set parameters for the rule-based planner 502. Updated trajectories may then be generated 916 and simulated, with a highest-scoring trajectory being selected 917. In some cases, the generation of updated trajectories may be repeated multiple times until a terminating condition is reached.

Once a trajectory has been selected, block 920 performs an action enact that trajectory. In some cases the hybrid planner 310 may not be able to select a trajectory that meets all score requirements, in which case task decomposition 930 may be used to break the planning task into smaller, achievable sub-goals.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method for operating a vehicle, comprising:
prompting a large language model (LLM) to generate parameters for a rule-based planner based on historical data for vehicles in a road scene;
generating a trajectory using the parameters; and
performing a driving action to implement the trajectory.

2. The method of claim 1, further comprising:
generating a set of trajectories without LLM-generated parameters; and
simulating the set of trajectories to determine one or more respective scores, before prompting the LLM.

3. The method of claim 2, further comprising comparing the one or more respective scores to respective thresholds, wherein prompting is performed responsive to a determination that at least one of the one or more respective scores, for each of the set of trajectories, falls below the respective threshold.

4. The method of claim 2, wherein simulating the set of trajectories is performed with a constant-velocity real-time simulator.

5. The method of claim 1, further comprising decomposing a goal into a plurality of sub-goals, with the trajectory being generated to accomplish one of the plurality of sub-goals.

6. The method of claim 5, further comprising generating new code for the rule-based planner to implement the sub-goals using the LLM.

7. The method of claim 5, further comprising generating a semantic representation of the road scene in natural language, wherein decomposing the goal includes prompting the LLM with the semantic representation.

8. The method of claim 1, wherein prompting the LLM includes a history of positions, headings, and speeds for vehicles, pedestrians, and objects, along with a current lane identifier for vehicle.

9. The method of claim 1, wherein the parameters include a lateral offset of a vehicle relative to a lane center, a fraction of a speed limit in free traffic, a fallback speed in free traffic, a minimum distance to a lead car, a minimum time to the lead car, a maximum acceleration, and a maximum deceleration.

10. The method of claim 1, wherein the driving action is selected from the group consisting of a braking action, a steering action, and an acceleration action.

11. A system for operating a vehicle, comprising:
a hardware processor; and
a memory that stores a computer program which, when executed by the hardware processor, causes the hardware processor to:
prompt a large language model (LLM) to generate parameters for a rule-based planner based on historical data for vehicles in a road scene;
generate a trajectory using the parameters; and
perform a driving action to implement the trajectory.

12. The system of claim 11, wherein the computer program further causes the hardware processor to:
generate a set of trajectories without LLM-generated parameters; and
simulate the set of trajectories to determine one or more respective scores, before prompting the LLM.

13. The system of claim 12, wherein the computer program further causes the hardware processor to compare the one or more respective scores to respective thresholds, wherein prompting is performed responsive to a determination that at least one of the one or more respective scores, for each of the set of trajectories, falls below the respective threshold.

14. The system of claim 12, wherein the computer program further causes the hardware processor to similar the set of trajectories with a constant-velocity real-time simulator.

15. The system of claim 11, wherein the computer program further causes the hardware processor to decompose a goal into a plurality of sub-goals, with the trajectory being generated to accomplish one of the plurality of sub-goals.

16. The system of claim 15, wherein the computer program further causes the hardware processor to generate new code for the rule-based planner to implement the sub-goals using the LLM.

17. The system of claim 15, wherein the computer program further causes the hardware processor to generate a semantic representation of the road scene in natural language, wherein decomposing the goal includes prompting the LLM with the semantic representation.

18. The system of claim 11, wherein a prompt to the LLM includes a history of positions, headings, and speeds for vehicles, pedestrians, and objects, along with a current lane identifier for vehicle.

19. The system of claim 11, wherein the parameters include a lateral offset of a vehicle relative to a lane center, a fraction of a speed limit in free traffic, a fallback speed in free traffic, a minimum distance to a lead car, a minimum time to the lead car, a maximum acceleration, and a maximum deceleration.

20. A vehicle, comprising:
a hardware processor;
an equipment control unit (ecu) that controls at least one driving system of the vehicle; and
a memory that stores a computer program which, when executed by the hardware processor, causes the hardware processor to:
prompt a large language model (LLM) to generate parameters for a rule-based planner based on historical data for vehicles in a road scene;
generate a trajectory using the parameters; and
trigger the ECU to perform a driving action to implement the trajectory, selected from the group consisting of a braking action, a steering action, and an acceleration action.
